(19) United States
(12) Patent Application Publication
(10) Pub. No.: US 2021/0241425 A1
(43) Pub. Date: Aug. 5, 2021

(54) IMAGE PROCESSING APPARATUS, IMAGE PROCESSING SYSTEM, IMAGE PROCESSING METHOD, AND MEDIUM

(71) Applicant: CANON KABUSHIKI KAISHA, Tokyo (JP)

(72) Inventors: Hikaru Uchidate, Kanagawa (JP); Hiroichi Yamaguchi, Kanagawa (JP)

(21) Appl. No.: 17/159,481

(22) Filed: Jan. 27, 2021

(30) Foreign Application Priority Data
Jan. 31, 2020 (JP) 2020-015533

(51) Int. Cl. G06T 5/00; G06T 5/50; G02B 27/01

(52) U.S. Cl. CPC G06T 5/001; G06T 19/006; G02B 27/0172; G06T 5/50

(57) ABSTRACT

There is provided with an image processing apparatus. An acquisition unit acquires, frame by frame, a video to be displayed in a display unit that is obtained by performing rendering processing on each frame of a captured video. An estimation unit estimates an ID of a frame to be acquired by the acquisition unit. A determination unit determines a drop in the frame rate of the video acquired by the acquisition unit, based on a comparison between an ID of a frame acquired by the acquisition unit and the ID estimated by the estimation unit.

### BACKGROUND OF THE INVENTION

### Field of the Invention

The present invention relates to an image processing apparatus, an image processing system, an image processing method, and a medium, and specifically related to a technique for displaying an image in an HMD.

### Description of the Related Art

In recent years, a mixed reality (MR) technique is known as a technique for seamlessly merging a real world and a virtual world in real time. A method of using a video see-through HMD (head mounted display, head mounted display apparatus) is known as one of the MR techniques. The video see-through HMD includes an imaging device, and a captured image (subject image) is obtained by capturing a subject. Then, a rendered image (MR image or mixed reality image) in which a CG (computer graphics) image is rendered on the captured image is generated, and a person on whom the HMD is mounted observes the rendered image (display image) that is displayed in a display device such as a liquid crystal or an organic EL.

In the video see-through HMD, because it takes time for generating a rendered image and the like, the update rate of the rendered image fluctuates, and the HMD user may suffer from visually induced motion sickness. In order to reduce the visually induced motion sickness, Japanese Patent Laid-Open No. 2019-184830 proposes a technique for detecting a state in which display images having high similarity are successively displayed, that is, the drop in the update rate. In the technique disclosed in Japanese Patent Laid-Open No. 2019-184830, when the update rate has dropped, the rendered image is corrected in accordance with the movement of the head of the HMD user, and the corrected image is displayed as the display image.

### SUMMARY OF THE INVENTION

According to an embodiment of the present invention, an image processing apparatus comprises: an acquisition unit configured to acquire, frame by frame, a video to be displayed in a display unit that is obtained by performing rendering processing on each frame of a captured video; an estimation unit configured to estimate an ID of a frame to be acquired by the acquisition unit; and a determination unit configured to determine a drop in the frame rate of the video acquired by the acquisition unit, based on a comparison between an ID of a frame acquired by the acquisition unit and the ID estimated by the estimation unit.

According to another embodiment of the present invention, an image processing apparatus comprises: an image capturing unit configured to capture a video including a plurality of frames; an acquisition unit configured to acquire, frame by frame, a video obtained by performing rendering processing on each frame of the captured video; a correction unit configured to perform image correction on a frame acquired by the acquisition unit; and a display unit configured to display a video output from the correction unit, wherein a period in which the display unit displays a video is divided into a plurality of subperiods, a. corresponding input period is prescribed to each of the plurality of subperiods, the display unit is further configured to update the frame to be displayed at periodical update timings, and the correction unit is further configured to determine whether or not the frame to be displayed in the display unit at a specific update timing has been acquired by the image capturing unit at the input period corresponding to the subperiod that includes the update timing, and perform image correction on a frame to be displayed in the display unit at the specific update timing in accordance with a result of the determination.

According to still another embodiment of the present invention, an image processing system comprises: an image capturing unit configured to capture a video including a plurality of frames; an assignment unit configured to assign an ID to each frame of the acquired video; an image processing unit configured to output, frame by frame, a video to be displayed in a display unit by performing rendering processing on each frame of the video; an estimation unit configured to estimate an ID of a frame to be output from the image processing unit; and a. determination unit configured to determine a drop in frame rate of the video output from the image processing unit, based on comparison between the ID of a frame output from the image processing unit and the ID estimated by the estimation unit.

According to yet another embodiment of the present invention, an image processing method comprises: acquiring, frame by frame, a video to be displayed in a display unit that is obtained by performing rendering processing on each frame of a captured video; estimating an ID of a frame to be acquired; and determining a drop in the frame rate of the acquired video, based on a comparison between an ID of an acquired frame and the estimated ID.

According to still yet another embodiment of the present invention, a non-transitory computer-readable medium stories a program which, when executed by a computer comprising a processor and a memory, causes the computer to perform a method comprising: acquiring, frame by frame, a video to be displayed in a display unit that is obtained by performing rendering processing on each frame of a captured video; estimating an ID of a frame to be acquired; and determining a drop in the frame rate of the acquired video, based on a comparison between an ID of an acquired frame and the estimated ID.

Further features of the present invention will become apparent from the following description of exemplary embodiments (with reference to the attached drawings).

### BRIEF DESCRIPTION OF THE DRAWINGS

FIG. 1 is a diagram illustrating a configuration of an image processing system according to one embodiment.

FIG. 2 is a functional block diagram of the image processing system according to one embodiment.

FIG. 3 is a functional block diagram of an image processing unit 1205.

FIGS. 4A and 4B are diagrams illustrating a delay in rendering processing.

FIG. 5 is a diagram illustrating image correction to be performed on a rendered image.

FIG. 6 is a flowchart of processing to be performed by an ID estimation unit 1311.

FIG. 7 is a flowchart of processing to be performed by an ID comparison unit 1312.

FIG. 8 is a diagram illustrating image correction to be performed on a rendered image.

FIG. 9 is a diagram illustrating operations of the image processing apparatus in one embodiment.

FIG. 10 is a flowchart of processing to be performed by the ID estimation unit 1311.

FIGS. 11A and 11B are diagrams illustrating operations of the image processing apparatus in one embodiment.

FIG. 12 is a diagram illustrating a configuration of a computer to be used in one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

With the method described in Japanese Patent Laid-Open No. 2019-184830, when display images having high similarity are successively displayed, the rendered image is corrected. On the other hand, in a video see-through HMD, there are cases where the update rate of the captured image (that is, the frame rate of a video to be obtained by an imaging device) is different from the update rate of the display image (that is the frame rate of a video to he displayed in a display device. In such cases, with the method described in Japanese Patent Laid-Open No. 2019-184830, it is possible to correct a rendered image at a timing in which correction is not needed, for example. Thus, a new method for detecting the change in the update rate of the rendered image (that is, a frame rate of a video obtained by rendering a CG image on a captured video) in order to effectively reduce the visually induced motion sickness is required.

One embodiment of the present invention can detect the change in the update rate of the rendered image in order to reduce the visually induced motion sickness when the HMD is used.

### Embodiment 1

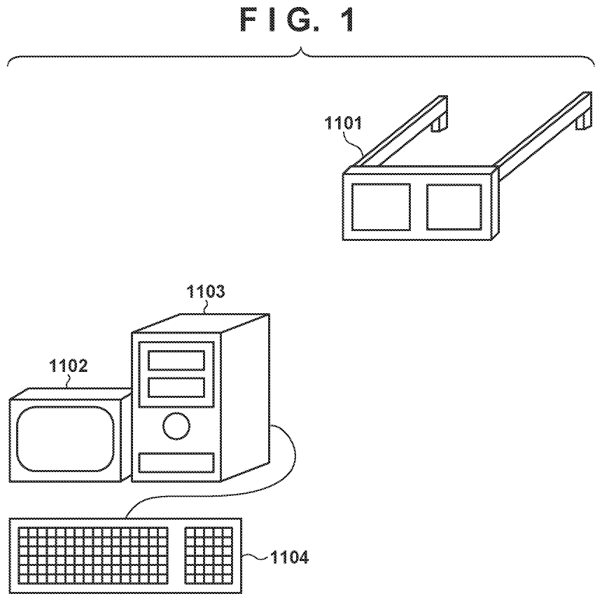

FIG. 1 shows the configuration of an image display system according to Embodiment 1. The image display system shown in 1 includes an HMD (head mounted display) 1101 and an image processing apparatus 1103. The HMD 1101 is to be mounted on a head of a user. The HMD 1101 can include an image capturing unit, an image display unit, a communication unit that communicates with the image processing apparatus 1103, and controller that controls these units.

In the present embodiment, the HMD 1101 transmits a captured image captured by the image capturing unit to the image processing apparatus 1103, which is an external apparatus. The image processing apparatus 1103 generates a rendered image by superimposing a CG image on the captured image based on the position and orientation of the HMD 1101, and transmits the rendered image to the HMD 1101. The HMD 1101 displays the rendered image received from the image processing apparatus 1103 in the image display unit as a display image. The user of the HMD 1101 can experience the MR space by mounting the HMD 1101.

The image processing apparatus 1103 includes a generation unit that generates a rendered image, and can communicated with the HMD 1101 via a communication unit in the image processing apparatus 1103. The image processing apparatus 1103 is an external apparatus such as a personal computer or a workstation that is different from the HMD 1101. Also, the image processing apparatus 1103 may include a console unit 1104 such as a keyboard. With the console unit 1104, data, a command, and the like can be input to the image processing apparatus 1103. Also, the image processing apparatus 1103 may include a display unit 1102 that displays an operation result according to the input data and command.

In FIG. 1, the image processing apparatus 1103 and the HMD 1101 are shown as different pieces of hardware. However, the image processing apparatus 1103 and the HMD 1101 may be integrated. In this case, the functions that the image processing apparatus 1103 has are implemented in the HMD 1101.

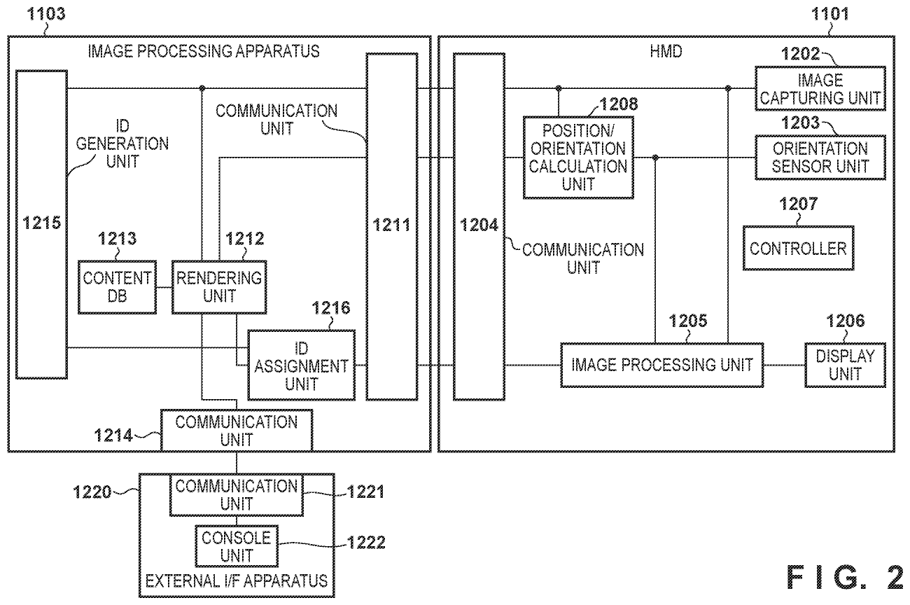

FIG. 2 is a functional block diagram illustrating the functions that the image display system according to the present embodiment has. The HMD 1101 includes an image capturing unit 1202, a display unit 1206, a communication unit 1204, an orientation sensor unit 1203, a position/orientation calculation unit 1208, an image processing unit 1205, a controller 1207, and other functional units (not illustrated).

The image capturing unit 1202 is an image sensor such as a CCD, and captures a video (captured video) of a subject by capturing the outside. In this way, the image capturing unit 1202 can obtain a captured video constituted by a plurality of frames (captured images). The image capturing unit 1202 can acquire the captured image at a predetermined update rate.

The display unit 1206 can display a display image. In the present embodiment, a rendered image generated by the image processing apparatus 1103 is transferred to the HMD 1101, and the display unit 1206 can display the transferred image as the display image. This rendered image corresponds to one frame of the video to be displayed in the display unit 1206. With such a configuration, the user who has mounted the HMD can view a superimposed image between a CG image and a captured image that is generated by the image processing apparatus 1103. The display unit 1206 includes optical systems for presenting the display image to the eyes of the user, and the optical systems are attached in front of the respective eyes of the user.

The communication unit 1204 can transmit and receive images and control signals to and from the image processing apparatus 1103. The communication unit 1204 can communicate with the image processing apparatus 1103 via the small scale wireless network. WLAN (wireless local area network) and WPAN (wireless personal area network) are examples of the small scale wireless network. On the other hand, the HMD 1101 and the image processing apparatus 1103 may be connected using a wired communication method. In the present embodiment, the communication unit 1204 can transmits the captured video captured by the image capturing unit 1202 to the image processing apparatus 1103 frame by frame. Also, the communication unit 1204 can acquire, frame by frame, video to be displayed in the display unit 1206 that is obtained by the image processing apparatus 1103 performing rendering processing on each frame of the captured video.

The orientation sensor unit 1203 is a sensor for measuring the position and orientation of the HMD. The orientation sensor unit 1203 can output an angular velocity or an acceleration regarding each axis, or orientation information (quaternion). The position/orientation calculation unit 1208 can calculate the position and orientation of the HMD 1101 based on the information output from the orientation sensor unit 1203. In the following, a case where the position/orientation calculation unit 1208 calculates the position and orientation of the HMD based on the angular velocity will be described, but the position/orientation calculation unit 1208 may perform the processing using the quaternion.

The image processing unit 1205 processes an image received from the image processing apparatus 1103. The specific functions of the image processing unit 1205 will be described later. The controller 1207 controls the overall operations of the HMD 1101.

The image processing apparatus 1103 includes a. communication unit 1211, a content DB 1213, a rendering unit 1212, an ID generation unit 1215, an ID assignment unit 1216, a communication unit 1211, and other functional units (not illustrated).

The communication unit 1211 can transmit and receive an image and control signals to and from the HMD 1101. In the present embodiment, the communication unit 1211 can acquire a captured video captured by the image capturing unit 1202 from the image processing apparatus 1103. Also, the communication unit 1211 can transmit the video obtained by the rendering unit 1212 to the HMD 1101.

The rendering unit 1212 performs rendering processing on each frame of the captured video captured by the image capturing unit 1202. The rendering unit 1212 can generate a rendered image by generating a CG image and superimposing the generated CG image on the captured image received from the HMD 1101. The rendering unit 1212 can superimpose a CG image acquired from the content DB 1213 that stores CG contents that are virtual images on a captured image, for example.

The ID generation unit 1215 issues an ID to each frame (captured image) of the video received from the HMD 1101. The ID generation unit 1215 can issue the ID according to the update rate of the captured image (hereinafter, the ID issued by the ID generation unit 1215 will he called as an “issuance ID”). Also, the ID assignment unit 1216 assigns an issuance ID issued by the ID generation unit 1215 to a rendered image output from the rendering unit 1212. Note that instead of the ID generation unit 1215 and the ID assignment unit 1216, the image capturing unit 1202 may assign the issuance ID to each frame of the captured image. These functions will be described later.

The communication unit 1211 communicates with an external interface apparatus 1220. The external interface apparatus 1220 is an apparatus that is used when the user performs an operation on the image processing apparatus 1103, and corresponds to the console unit 1104. The external interface apparatus 1220 includes a communication unit 1221 for communicating with the image processing apparatus 1103, a console unit 1222 that is to be operated by the user, and other functional units (not illustrated).

The functions shown in FIG. 2 can each be realized by hardware having a corresponding configuration. On the other hand, some of or all of the functions shown in FIG. 2 may be realized by software. For example, the functions of the position/orientation calculation unit 1208, the rendering unit 1212, the ID generation unit 1215, and the ID assignment unit 1216 may be realized by software, and the other functions may be realized by hardware.

When the aforementioned functions are realized by software, a computer including a processor and a memory can be used. In this case, as a result of the processor executing a program including commands corresponding to respective functions of the units that is stored in the memory, the functions of the units can be realized.

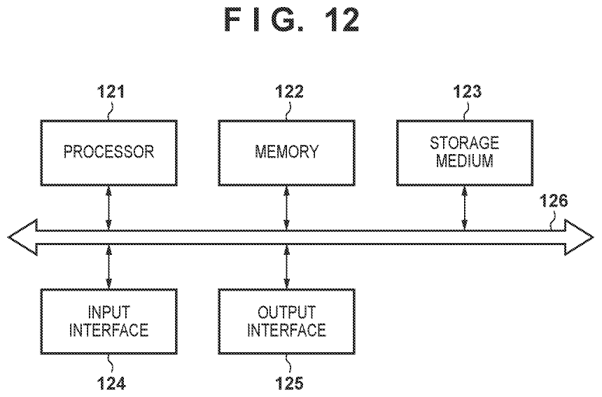

FIG. 12 is a diagram illustrating a basic configuration of such a computer. In FIG. 12, a processor 121 is a CPU, for example, and controls the overall operations of the computer. A memory 122 is a RAM, for example, and temporarily stores a program, data, and the like. A storage medium 123 that can be read by the computer is a hard disk, a CD-ROM, or the like, and stores a program, data, and the like over a long period of time. In the present embodiment, the program for realizing functions of the units that is stored in the storage medium 123 is read out to the memory 122. Then, the processor 121 operates in accordance with the program in the memory 122, and as a result, the functions of the units are realized.

In FIG. 12, an input interface 124 is an interface for acquiring information from an external apparatus. Also, an output interface 125 is an interface for outputting information to an external apparatus. A bus 126 connects the units described above for enabling the exchange of data.

The HMD 1101 and the image processing apparatus 1103 can each include at least some of the functions that the image processing system shown in FIG. 2 has. The functions that the HMD 1101 and the image processing apparatus 1103 respectively have may be different from those shown in FIG. 2. For example, at least one of the ID generation unit 1215 and the ID assignment unit 1216 may be included in the HMD 1101 instead of the image processing apparatus 1103. Also, at least one of an ID estimation unit 1311 and an ID comparison unit 1312, which will be described later, may be included in the image processing apparatus 1103 instead of the HMD 1101. Also, the functions of the image display system according to one embodiment of the present invention may be distributed among a plurality of information processing apparatuses that are connected via a network. For example, the image processing apparatus 1103 may be configured by a plurality of information processing apparatuses that are connected via a network.

In the following, a case will be described where the HMD 1101 transmits a captured image and position/orientation information of the HMD 1101 to the image processing apparatus 1103, and the image processing apparatus 1103 superimposes a CG image on the captured image in accordance with the position/orientation information of the HMD 1101. That is, the position/orientation calculation unit 1208 of the HMD 1101 calculates the position and orientation of the HMD 1101 based on the captured image obtained by the image capturing unit 1202 and the measurement data received from the orientation sensor unit 1203. Also, the HMD 1101 transmits the captured image obtained by the image capturing unit 1202 and the position/orientation information of the HMD 1101 calculated by the position/orientation calculation unit 1208 to the image processing apparatus 1103 via the communication unit 1204. However, the present invention is not limited to such a configuration. For example, the configuration may be such that the HMD 1101 transmits the position/orientation information to the image processing apparatus 1103, the image processing apparatus 1103 generates a CG image based on the position/orientation information, and transmits the CG image to the HMD 1101, and the HMD 1101 superimposes the CG image on the captured image. Also, the image processing apparatus 1103 may include the position/orientation calculation unit 1208. In this case, the image processing apparatus 1103 may calculate the position and orientation of the HMD 1101, and superimpose a CG image on the captured image transmitted from the HMD 1101 based on the calculated position and orientation.

In any case, the rendering unit 1212 renders a CG image based on the position/orientation information. Here, depending on the load when a. CG image is rendered, there may be a case where the update rate of the CG image generated by the rendering unit 1212 drops, and the update rate of the rendered image obtained by superimposing the CG image on a captured image drops. In the present embodiment, the ID of a frame to be output from the rendering unit 1212 is estimated, and this ID is compared with the ID of the frame that is actually output from the rendering unit 1212, and with this, whether or not the update rate of the rendered image has dropped is determined.

In Embodiment 1, the ID estimation unit 1311 of the HMD 1101 estimates the ID of a frame to be output from the rendering unit 1212 according to the frame rate of the video that the image processing apparatus 1103 receives from the HMD 1101. Hereinafter, the estimation and comparison of the ID of a frame in the present embodiment will be described.

The ID generation unit 1215 of the image processing apparatus 1103 issues an issuance ID according to the update rate of the captured image received from the HMD 1101. The ID generation unit 1215 can retain the ID until the rendered image output from the rendering unit 1212 is updated. The ID assignment unit 1216 acquires the issuance ID from the ID generation unit 1215 at a timing at which the rendered image from the rendering unit 1212 is updated, and assigns the issuance ID to the rendered image output from the rendering unit 1212. In this way, the issuance ID issued to a frame (captured image) of the captured video received from the HMD 1101 is assigned to the rendered image obtained by superimposing a CG image on the same frame. The rendered image to which the issuance ID is assigned is thereafter transmitted to the HMD 1101 via the communication unit 1211.

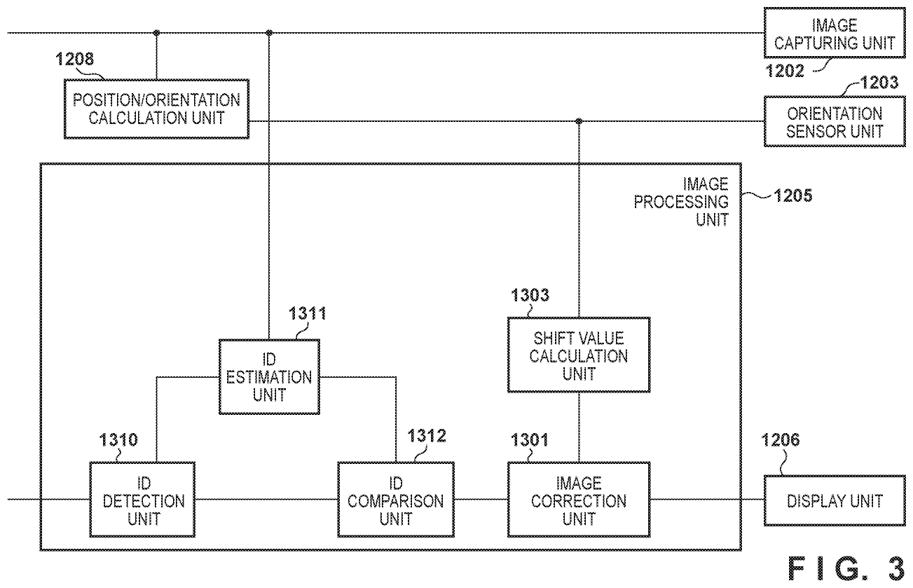

FIG. 3 is a block diagram illustrating the configuration of the image processing unit 1205 included in the HMD 1101. An ID detection unit 1310 detects the issuance ID assigned to a rendered image received from the image processing apparatus 1103. The ID estimation unit 1311 estimates the ID of a frame of a captured video to be acquired by the communication unit 1204. The ID estimation unit 1311 can estimates the ID of a frame to be output from the rendering unit 1212 according to the frame rate of the video that the image processing apparatus 1103 receives from the HMD 1101. In the example in FIG. 3, the ID estimation unit 1311 updates the ID to be estimated (estimation ID) at a period corresponding to the frame rate of the captured video. For example, the ID estimation unit 1311 can update the estimation ID at an update timing of the frame of the captured video acquired by the image capturing unit 1202.

The ID comparison unit 1312 determines whether or not the frame rate of the video that is output from the rendering unit 1212 and acquired by the communication unit 1204 has dropped, based on the comparison between the issuance ID of a frame of the captured video acquired by the communication unit 1204 and the estimation ID. In the example in FIG. 3, the ID comparison unit 1312 can determine how much the update rate of the rendered image has dropped.

In this way, if the ID comparison unit 1312 has determined that the frame rate of the video output from the rendering unit 1212 has dropped, the rendered image received from the image processing apparatus 1103 can be corrected. For example, an image correction unit 1301 can perform image correction based on the change in orientation. of the display unit 1206. In the example in FIG. 3, a shift value calculation unit 1303 calculates a shift correction amount of the rendered image based on angular velocity information received from the orientation sensor unit 1203. Also, the image correction unit 1301 performs shift correction on the rendered image based on the determination result of the ID comparison unit 1312 and the shift correction amount calculated by the shift value calculation unit 1303, and transmits the corrected rendered image to the display unit 1206.

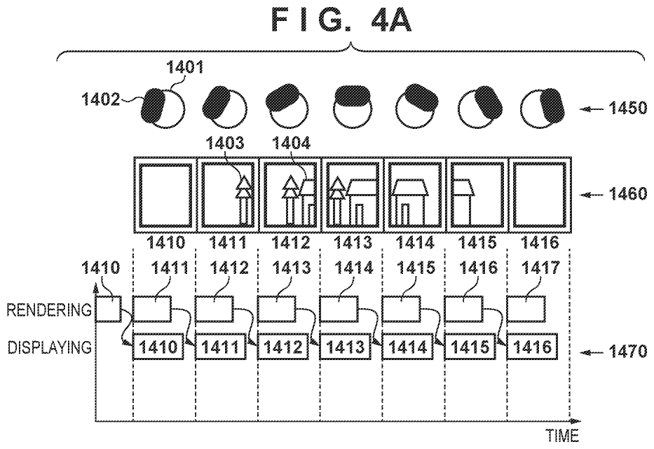

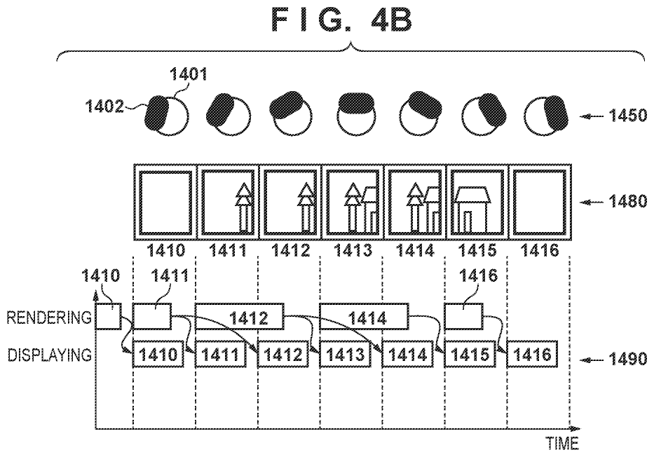

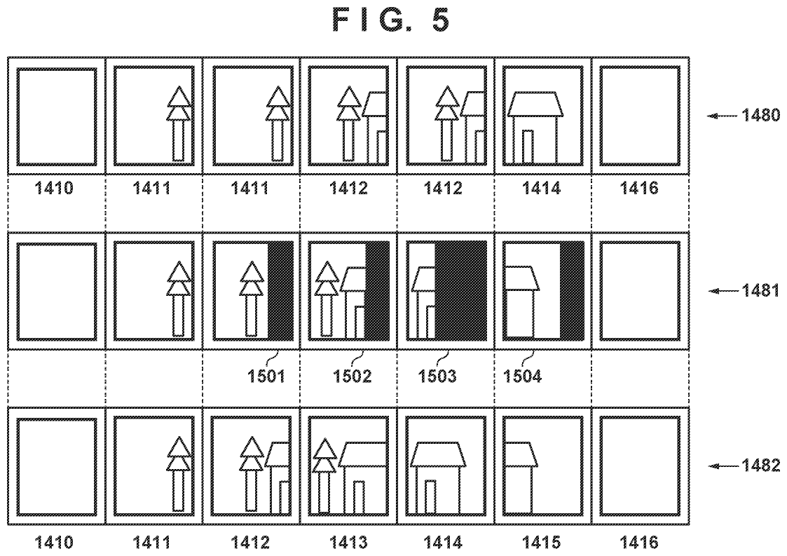

The method of correcting the rendered image will be described with reference to FIGS. 4A, 4B, and 5. FIG. 4A shows the relationship between a head movement 1450 of a head 1401 on which the HMD is mounted and a rendered image 1460. For the sake of description, FIG. 4A shows a case where the update rate of the captured image matches the update rate of the display image, and the update rate of the rendered image has not dropped. The head movement 1450 shows the positions of a HMD 1402 viewed from the above of the head 1401, and in this diagram, the user is making a movement of turning from left to right. In the diagram, time flows from left to right. Also, in order to make an easily understandable description, the head 1401 makes a uniform motion. The rendered image 1460 shows rendered images obtained by superimposing CG images 1403 and 1404 that are generated in accordance with the orientation of the head 1401 on captured images, and numbers of the rendered images. For example, the CG image 1403 is superimposed on a rendered image 1411, and the CG image 1404 is superimposed on a rendered image 1412. Timing 1470 shows generation timings of the rendered images 1410 to 1416 and display timings at which the rendered images 1410 to 1416 are displayed as the display image.

FIG. 4B shows a case where the update rate of the rendered image drops. Although a rendered image 1480 is generated in accordance with the orientation of the head 1401, it takes time for rendering the rendered images 1412 and 1414, as shown in timing 1490, and the rendering is not ended in a specified time. Therefore the rendered images 1413 and 1415 are not rendered. On the other hand, as shown as the rendered image 1480, the rendered images 1411 and 1412 are each displayed twice successively. In this way, if the rendering processing for displaying the rendered images 1412 and 1414 is not ended in the specified time, the update rate of the rendered image drops at this time. The rendered images 1411 and 1412 are successively displayed in the display unit 1206 due to this drop in the update rate, and as a result, the update rate of the display image ostensibly drops. Therefore, the user of the HMD 1402 may feel a sense of incongruity, or may suffer from visually induced motion sickness.

FIG. 5 is a diagram illustrating a method for generating a display image 1481 by correcting the rendered image 1480. For example, image correction can be performed on a rendered image by performing shifting processing on the rendered image. In this example, when the rendered image 1411 is displayed second time, a display image 1501 is generated by shifting the rendered image 1411 leftward by a shift amount corresponding to one frame's worth of head movement amount. According to such a configuration, the display image 1501 can be displayed that is similar to the rendered image 1412 displayed when the update rate of the rendered image has not dropped, which is shown as a rendered image 1482. Similarly, as a result of shifting the rendered image 1412 by an amount corresponding to one frame and two frames, display images 1502 and 1503 are obtained, and as a result of shifting the rendered image 1414 by an amount corresponding to one frame, a display image 1504 can be obtained.

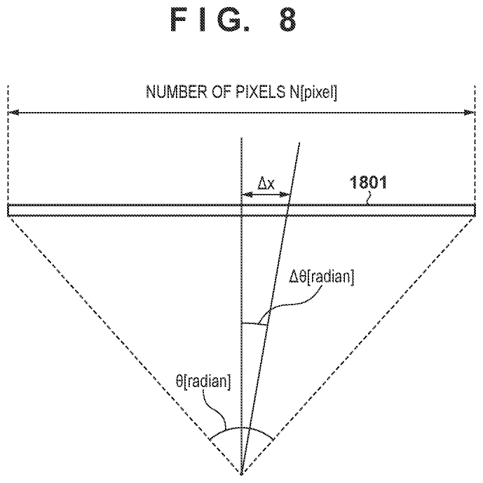

The specific shift correction amount can be obtained as follows, FIG. 8 is a diagram illustrating a method for calculating the shift correction amount (number of pixels) from the change in orientation (shift angle). FIG. 8 shows a calculation method when a motion of swinging the neck in a lateral direction (horizontal direction) is performed. A display unit 1801 of the HMD 1101 is shown in FIG. 8, and the horizontal angle of view when the user observes the display unit 1801 is θ [radian]. When the shift angle of the neck for one frame is Δθ [radian/frame], and the number of pixels of the display unit 1801 is N [pixel], the shift correction amount Δx [pixel] in the lateral direction (horizontal direction) can be obtained from the following formula.

Δx=N tan(Δθ)/2 tan(θ/2)

In the above formula, the shift angle of the neck for one frame Δθ can be obtained by integrating the angular velocity of the head over one frame. Note that when a motion of swinging the neck in a longitudinal direction (vertical direction) is performed as well, the shift correction amount in the longitudinal direction (vertical direction) can be similarly obtained. In the example in FIG. 8, the shift correction amount Δx is calculated based on the shift amount of the central portion of the display unit 1801, but another calculation method may be used.

Note that, the region where a rendered image is not present as a result of the rendered image having been shifted can be set to a black region. On the other hand, the rendered image may be corrected by performing cutout processing from the rendered image. For example, a rendered image whose size is larger than the size of the display image is received from the image processing apparatus 1103, an image at a portion corresponding to the change in orientation is cut out from the rendered image as the display image, and as a result, the image correction can be performed while reducing the region where the rendered image is not present in the display image. Also, in the example in FIG. 5, the head moves in the left and right direction, and therefore correction for shifting the image in the left and right direction is performed, but when the head moves in the up and down direction, correction for shifting the image in the up and down direction can be performed.

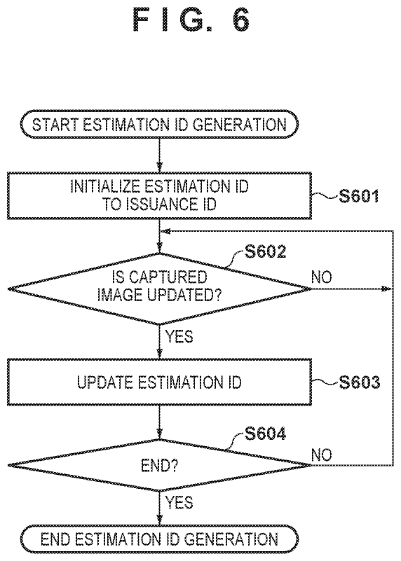

FIG. 6 is a flowchart of processing to be performed by the ID estimation unit 1311. In the following description, the issuance order of the issuance IDs to be issued by the ID generation unit 1215 has been determined. For example, the ID generation unit 1215 can issue ID1 to a captured image in Frame 1, and issue ID2 and onward respectively to captured images in Frame 2 and onward.

In step S601, the ID estimation unit 1311 initializes the estimation ID. The ID estimation unit 1311, when starting estimation, initializes the estimation ID to the issuance ID. For example, the ID estimation unit 1311 can initialize the estimation ID to ID1 that is the issuance ID regarding the first captured image (Frame 1).

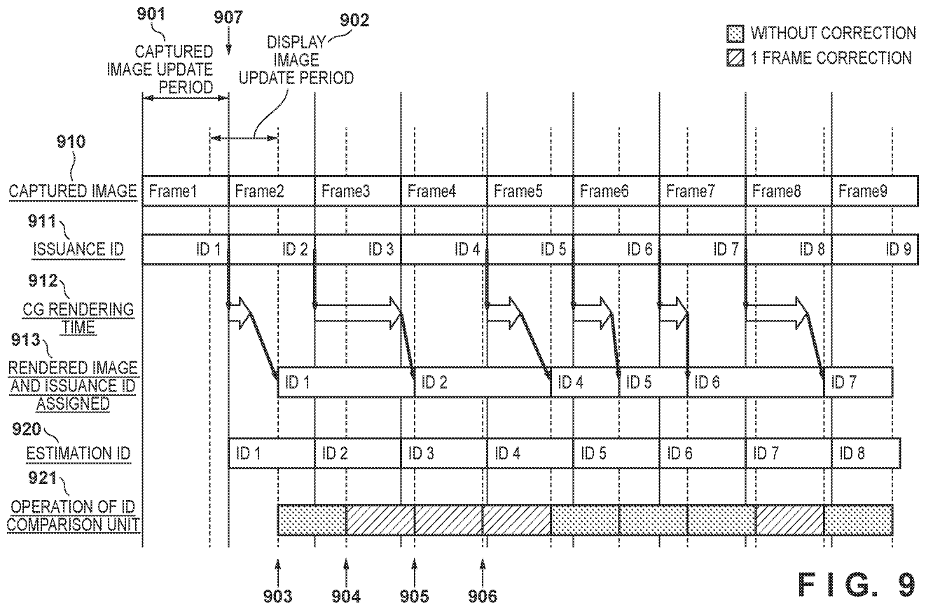

In step S602, the ID estimation unit 1311 determines whether or not the captured image from the image capturing unit 1202 is updated. If it is determined that the captured image is updated, in step S603, the ID estimation unit 1311 updates the estimation ID. The ID estimation unit 1311 can generate the estimation ID, which corresponds to an estimated generation ID which is estimated as being assigned to the latest rendered image that is transmitted to the HMD 1101 if the delay does not occur in generation of the rendered image. The ID estimation unit 1311 can update the estimation ID based on the issuance order of the issuance IDs with respect to the frames to he acquired by the communication unit 1204. In an example in FIG. 9, which will be described later, the ID generation unit 1215 increments the issuance ID in order to update the issuance ID, and therefore the ID estimation unit 1311 also increments the estimation ID.

In step S604, the ID estimation unit 1311 determines whether or not an end instruction to end the generation of the estimation ID has been input. For example, the controller 1207, when ending image display, can input this end. instruction to the ID estimation unit 1311. If it is determined that the end instruction has not been input, the processing in steps S602 and S603 is repeated, and if it is determined that the end instruction has been input, the processing in FIG. 6 is ended.

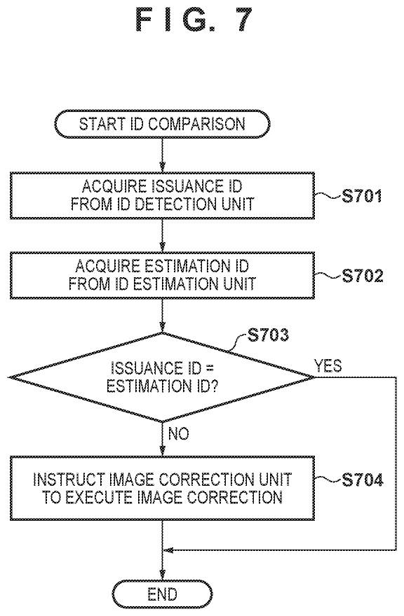

FIG. 7 is a flowchart of processing to be performed by the ID comparison unit 1312. In step S701, the ID comparison unit 1312 acquires the issuance ID that the ID detection unit 1310 has detected from the rendered image transmitted from the image processing apparatus 1103. Also, in step S702, the ID comparison unit 1312 acquires the current estimation ID that is generated by the ID estimation unit 1311.

In step S703, the ID comparison unit 1312 compares the issuance ID and the estimation ID that are obtained in steps S701 and S702. The fact that the issuance ID matches the estimation ID means that the update rate of the captured image and the update rate of the rendered image are the same. Therefore, the ID comparison unit 1312 determines that the update rate of the rendered image has not dropped. In this case, the processing in FIG. 7 regarding one rendered image transmitted from the image processing apparatus 1103 is ended, and the rendered image transmitted from the image processing apparatus 1103 is displayed in the display unit 1206 as the display image. On the other hand, if the issuance ID and the estimation ID are different, the ID comparison unit 1312 determines that the update rate of the rendered image has dropped relative to the update rate of the captured image. In this case, the ID comparison unit 1312 determines that the image correction is needed, and in step S704, the ID comparison unit 1312 instructs the image correction unit 1301 to execute image correction. In this way, if the ID comparison unit 1312 has determined that the frame rate of the video acquired by the communication unit 1204 has dropped, the image correction unit 1301 can perform image correction on the frame acquired by the communication unit 1204.

The ID comparison unit 1312, in step S703, can determine the delay in the rendering processing regarding the frame acquired by the communication unit 1204 based on the issuance ID and the estimation ID obtained in steps S701 and S702. Also, in step S704, the ID comparison unit 1312 can instruct the image correction unit 1301 to perform image correction according to the determined delay. In this case, the image correction unit 1301 can perform image correction based on the delay in the rendering processing regarding the frame acquired by the communication unit 1204. For example, if the ID comparison unit 1312 has determined that the generation of the rendered image is delayed by an amount corresponding to two frames, the image correction unit 1301 can instruct the image correction unit 1301 to perform image correction such that the movement of the HMD 1101 over two frames is compensated.

The effect of the processing according to the present embodiment will be described with reference to FIG. 9. An update period 901 of the captured image is shown in FIG. 9, and the solid lines indicate the update timings of the captured image. Also, in FIG. 9, an update period 902 of the display image is also shown, and the broken lines indicate the update timings of the display image to be output from the display unit 1206. As shown in FIG. 9, the update timing of the display image by the display unit 1206 is asynchronous with the update timing of the captured image by the image capturing unit 1202. As described above, in the HMD 1101, the update timings and the update periods may be asynchronous between the captured image and the rendered image. In the following, a case where the update period of the captured image is longer than the update period of the rendered image will he described, but the processing according to the present embodiment can be applied to different configurations.

The row indicated by 910 in FIG. 9 illustrates the manner of the image capturing unit 1202 updating the captured image. For example, the image capturing unit 1202 captures a captured image (Frame 1) over a period denoted as Frame 1, and when this period is ended, the captured image (Frame 1) is input to the rendering unit 1212 and the ID generation unit 1215 of the image processing apparatus 1103. In this way, the captured image is updated at intervals of the update period 901.

Also, the row indicated by 911 in FIG. 9 illustrates the manner of the ID generation unit 1215 generating the issuance ID. As shown in FIG. 9, the issuance ID is updated at timings at which the captured image is updated. For example, at timing 907 at which the captured image is updated, the ID generation unit 1215 issues ID1 as the issuance ID to the captured image (Frame 1), and updates the issuance ID to ID2.

The row indicated by 912 in FIG. 9 illustrates the CG rendering time. The rendering unit 1212 starts, at the timing at which the captured image is updated and input, the processing for generating the rendered image by superimposing a CG image on the captured image. As described above, the load of the rendering processing differs according to CG contents desired to be superimposed, and therefore it can be understood that the period of time required to generate the rendered image is not constant. In this way, in the image processing system, the capturing timing may be asynchronous with the rendering timing.

The row indicated by 913 in FIG. 9 illustrates the manner of the ID assignment unit 1216 assigning issuance IDs to rendered images generated by the rendering unit 1212. As described above, the ID generation unit 1215 can retain the issuance ID that has been issued to a captured image at the timing at which the rendering unit 1212 starts the rendering processing regarding the captured image. Also, at the first update timing of the display image after rendering of a CG image is ended, a rendered image to which the issuance ID retained by the ID generation unit 1215 is assigned is generated. The HMD 1101 acquires the rendered image generated in this way from the image processing apparatus 1103, and retains the rendered image.

The row indicated by 920 in FIG. 9 illustrates the manner of the ID estimation unit 1311 generating the estimation ID, As described above, in the present embodiment, the ID estimation unit 1311 updates the estimation ID in accordance with the update timing of the captured image (step S603). For example, at a timing 907, ID1 is issued to the captured image (Frame 1) as the issuance ID. Here, when the generation delay of the rendered image is not present, it is estimated that a rendered image having ID1 as the issuance ID that is obtained by the rendering processing performed on this captured image is input to the HMD 1101 at the next update timing of the display image. Therefore, the ID estimation unit 1311 in the present embodiment sets the estimation ID to ID1, at the timing 907. Also, the ID estimation unit 1311 repeats updating of the estimation ID at timings at which the captured image is updated, in accordance with the issuance order of the issuance IDs. In the example in FIG. 9, the estimation ID after update matches the issuance ID issued at the same timing.

The row indicated by 921 in FIG. 9 shows the result of comparison between the assign ID and the estimation ID performed by the ID comparison unit 1312. In FIG. 9, at timing 903 at which the display image is updated, the ID (ID1) of a rendered image that is generated matches the estimation ID (ID1), and therefore the ID comparison unit 1312 determines that the update rate of the rendered image has not dropped. Also, at timing 904 at which the display image is updated, the ID (IDI) of a rendered image that is generated does not match the estimation ID (ID2). Therefore, the ID comparison unit 1312 determines that the update rate of the rendered image has dropped. Also, the ID comparison unit 1312 can determine that the generation of the rendered image is delayed by one frame (one update period 901 of the captured image) based on the comparison between the issuance ID and the estimation ID. In this case, the image correction unit 1301 can shift the rendered image by a shift amount corresponding to one frame's worth movement amount of the head, and output the resultant image to the display unit 1206 as the display image,

As shown in FIG. 9, in the present embodiment, the period during which the display unit 1206 displays a video is divided into a plurality of subperiods (update periods 902 of display image). Also, a corresponding input period (ID1, ID2, etc. indicated by 911) is determined with respect to each of the plurality of subperiods (ID1, ID2, etc. indicated by 920). Also, the display unit 1206 updates the frame to be displayed at periodical update timings (timings 903, 904, etc.). It can be said that the ID comparison unit 1312 determines whether or not the frame (ID1 indicated by 913) to be displayed in the display unit 1206 at a specific update timing (e.g., timing 904) has been acquired by the image capturing unit 1202 at a specific input period (ID2). This specific input period is the input period (1D2) corresponding to the subperiod (ID2) that includes the specific update timing (timing 904). Also, it can be said that the image correction unit 1301 performs image correction on a frame to be displayed in the display unit 1206 at the specific update timing (timing 904) based on the determination result.

Note that, at timing 906 at which the display image is updated, although the rendered image (ID2) is displayed second time, the display image that is the same as that at the previous timing 905 need only be displayed in the display unit 1206. In the example in FIG. 9, the display image to be displayed at timing 906 is the same as the display image displayed at timing 905, and is not a display image obtained by performing image correction corresponding to one frame on the display image displayed at timing 905. In this way, according to the present embodiment, the rendered image can be suppressed from being corrected when the correction is not needed. Also, at timing 905 at which the display image is updated, although the rendered image (ID2) is displayed first time, the ID comparison unit 1312 can determine that the generation of the rendered image is delayed based on the comparison between the issuance ID and the estimation ID. As described above, according to the present embodiment, the drop in update rate of the rendered image can be easily detected. Moreover, in the present embodiment, the delay in generation of the rendered image can be detected by the processing in which IDs are compared, and therefore the processing load can be reduced.

As described above, according to the present embodiment, as a result of using the estimation ID, the drop in update rate of the rendered image can be detected. Specifically, in the present embodiment, as a result of updating the estimation ID according to the update rate of the captured image, the drop in update rate of the rendered image can be accurately detected. As a result, even if the update rate of the rendered image has dropped, an image that will not give a sense of incongruity to the HMD user can be displayed by performing image correction, and the visually induced motion sickness can be reduced.

### Embodiment 2

In Embodiment 1, the ID estimation unit 1311 updates the estimation ID according to the update rate of the captured image. However, the method of updating the estimation ID to be performed by the ID estimation unit 1311 is not limited to this method. For example, the ID estimation unit 1311 can update the estimation ID at a fixed period. In Embodiment 2, the estimation ID is updated at a period according to the update rate (frame rate of a video in the display unit 1206) of the display image. An image processing system according to Embodiment 2 can be configured similarly to Embodiment 1. In the following, the operations of an ID estimation unit 1311 in the present embodiment will be described.

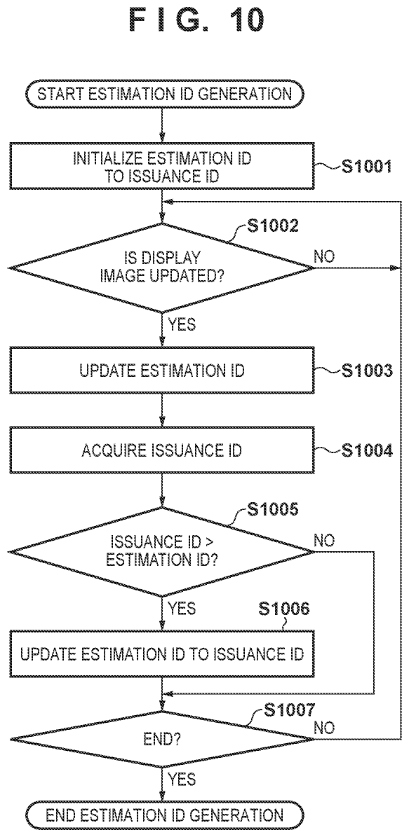

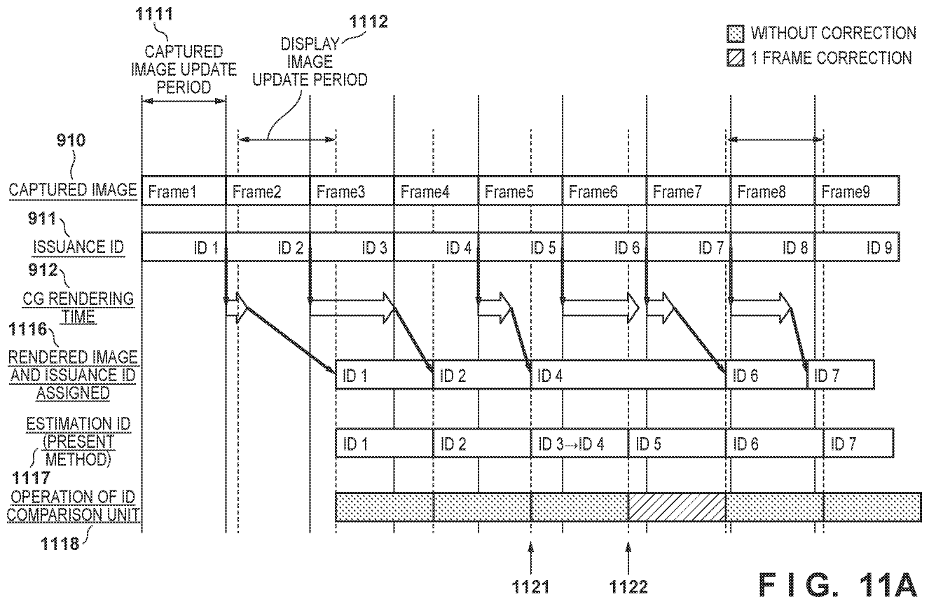

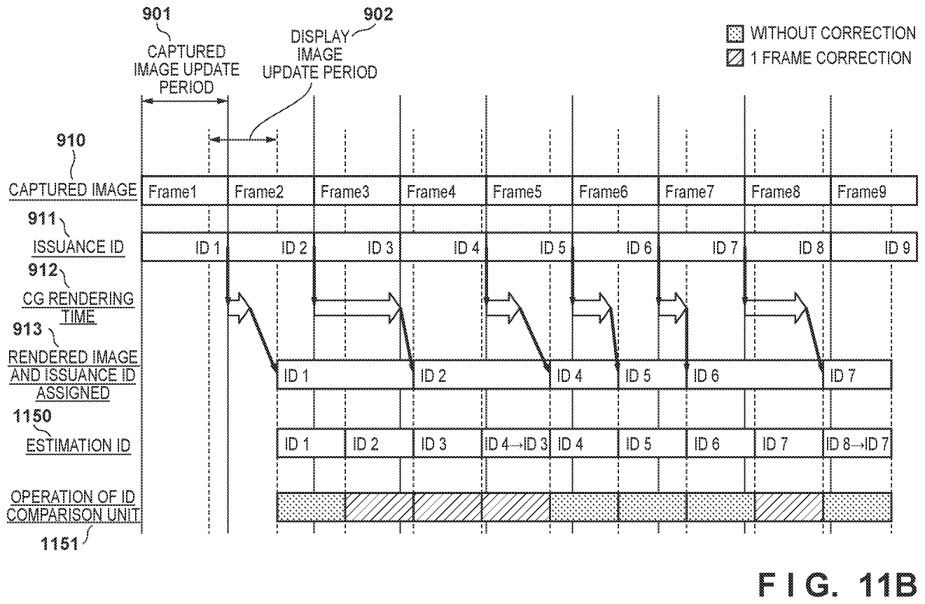

FIG. 10 is a flowchart illustrating the processing of the ID estimation unit 1311. In step S1001, the ID estimation unit 1311, when starting estimation, initializes an estimation ID to an issuance ID, similarly to step S601. In step S1002, the ID estimation unit 1311 determines whether or not the update timing of the frame of a video in a display unit 1206 has arrived. If it is determined that the update timing of the display image has arrived, in step S1003, the ID estimation unit 1311 updates the estimation ID. The ID estimation unit 1311 can update the estimation ID by estimating that a new rendered image is transmitted to the HMD 1101 at an update timing of the display image. In the present embodiment as well, the ID estimation unit 1311 can update the estimation ID in accordance with the issuance order of the issuance IDs. In an example in FIG. 11A, which will be described later, the ID estimation unit 1311 increments the estimation ID for updating the estimation ID.

On the other hand, when the update rate of the captured image does not match the update rate of the display image, it is possible that, because the update period of the estimation ID is longer than or shorter than the update period of the issuance ID, the issuance ID shifts from the estimation ID when the update rate of the rendered image has not dropped. Therefore, the ID estimation unit 1311 in the present embodiment can, when a prescribed condition is satisfied, correct the ID that is estimated in accordance with the issuance order of the issuance IDs.

In steps S1004 to S1006, the ID estimation unit 1311 can further correct the estimation ID that has been temporarily updated in step S1003. Here, a case will be described where the frame rate (update rate of captured image) of the captured video is faster than the frame rate of video in the display unit 1206 (update rate of display image). In step S1004, the ID estimation unit 1311 acquires the issuance ID assigned to the updated rendered image. in step S1005, the ID estimation unit 1311 compares the issuance ID acquired in step S1004 with the estimation ID updated in step S1003. Also, the ID estimation unit 1311, when the ID of a frame acquired by the communication unit 1204 advances relative to the estimation ID, corrects the estimation ID so as to be matched with the ID of the frame acquired by the communication unit 1204. In the example in FIG. 11A, if the estimation ID updated in step S1003 is smaller than the issuance ID of the rendered image, in step S1006, the ID estimation unit 1311 corrects the estimation ID so as to be matched with the latest issuance ID.

The processing in step S1007 is similar to that in step S604, and if an end instruction has not been input, the processing in steps S1002 to S1007 is repeated. When the end instruction is input, the processing in FIG. 10 is ended.

The effects of the processing according to the present embodiment will be described with reference to FIG. 11A, Similarly to FIG. 9, an update period 1111 of the captured image and an update period 1112 of the display image are shown in FIG. 11A, and the update period 1112 of the display image is longer than the update period 1111 of the captured image. The row indicated by 1116 shows the issuance ID of a rendered image generated by the rendering unit 1212, and the rendered image is updated in accordance with the update timing of the display image, as described above. The row indicated by 1117 shows the estimation ID.

Incidentally, since the update period 1112 of the display image is longer than the update period 1111 of the captured image, if the delay in generation of the rendered image is not present, at the update timing of the display image, while the estimation ID is increased by only one, the issuance ID of the rendered image is increased by one or more. On the other hand, the issuance ID will not be larger than the estimation ID. For example, at an update timing 1121 of the display image in FIG. 11A, the issuance ID of the rendered image is ID4, and if the delay in generation of the rendered image is not present, the issuance ID of the rendered image at a next update timing 1122 of the display image is estimated to he ID5 or more. Therefore, the ID estimation unit 1311 corrects, in step S1006, the estimation ID to ID4 so as to be matched with the issuance ID such that the estimation ID at the update timing 1122 becomes ID5. In this way, in the present embodiment, if issuance ID>estimation ID, the estimation ID is corrected such that the estimation ID matches the latest issuance ID of the rendered image.

According to the configuration described above, when the update period of the display image is longer than the update period of the captured image, the ID can be estimated with a simple method, and the drop in update rate of the rendered image can be detected. In this case as well, the ID comparison unit 1312 can determine the delay in generation of the rendered image in units of a frame (one update period 1112 of display image based on the comparison between the issuance ID and the estimation ID, and the image correction unit 1301 can correct the rendered image according to the delay in generation.

On the other hand, the method of correcting the estimation ID in steps S1004 to S1006 is not limited to the method described above. For example, the ID estimation unit 1311 may update the estimation ID that has been updated in step S1003 based on the difference between the update rate of the captured image and the update rate of the display image. This method may be used when the update rate of the display image is longer than the update rate of the captured image, or may he used when the update rate of the display image is shorter than the update rate of the captured image.

For example, FIG. 11B illustrates a method of generating the estimation ID when the update rate of the display image is shorter than the update rate of the captured image, similarly to FIG. 9. In FIG. 11B, the update period of the captured image is 24 fps, and the update period of the display image is 30 fps. In this example, the ID estimation unit 1311 decrements the estimation ID every time the update timing of the display image has arrived five times, in order to match the estimation ID to the generation ID when the delay in generation of the rendered image is not present. With such a method, the deviation in update between the generation ID and the estimation ID that occurs when the estimation ID is updated according to the update period 902 of the display image is corrected, and the drop in update rate of the rendered image can be accurately detected. For example, in FIG. 11B, the drop in update rate is not present with respect to the rendered images of ID4 to ID6, and therefore the image correction need not be performed. In the example in FIG. 11B, the estimation ID is corrected such that the deviation between the update period of the captured image and the update period of the display image is reflected on the estimation ID. As described above, the method of correcting the estimation ID is not specifically limited.

As described above, according to the present embodiment, as a result of using the estimation ID, the drop in update rate of the rendered image can be detected. Specifically, in the present embodiment, the estimation ID is updated according to a fixed timing such as the update rate of the captured image, and the estimation ID is corrected if needed, and as a result, the drop in update rate of the rendered image can be accurately detected. Therefore, similarly to Embodiment 1, the visually induced motion sickness can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may he provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to he understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-015533, tiled Jan. 31, 2020, which is hereby incorporated by reference herein in its entirety.

What is claimed is:

1. An image processing apparatus comprising:
an acquisition unit configured to acquire, frame by frame, a video to be displayed in a display unit that is obtained by performing rendering processing on each frame of a captured video;
an estimation unit configured to estimate an ID of a frame to be acquired by the acquisition unit; and
a determination unit configured to determine a drop in the frame rate of the video acquired by the acquisition unit, based on a comparison between an ID of a frame acquired by the acquisition unit and the ID estimated by the estimation unit.

2. The image processing apparatus according to claim 1, wherein the estimation unit is further configured to update an ID to be estimated at a period corresponding to a frame rate of the captured video.

3. The image processing apparatus according to claim 1, wherein the estimation unit is further configured to update an ID to be estimated at an update timing of a frame of the captured video acquired by an image capturing unit included in the image processing apparatus.

4. The image processing apparatus according to claim 1, wherein the estimation unit is further configured to update an ID to be estimated at a period corresponding to a frame rate of a video in the display unit.

5. The image processing apparatus according to claim 1, wherein the estimation unit is further configured to update an ID to be estimated at an update timing of a frame of a video in the display unit.

6. The image processing apparatus according to claim 1, wherein the estimation unit is further configured to update an ID to be estimated based on an issuance order of the ID to a frame to be acquired by the acquisition unit, and correct the ID to be estimated if a prescribed condition is satisfied.

7. The image processing apparatus according to claim 6,
wherein the frame rate of the captured video is faster than the frame rate of a video in the display unit, and
the estimation unit is further configured to, when the ID of the frame acquired by the acquisition unit advances relative to the ID estimated by the estimation unit, correct the estimated ID so as to match the ID of the frame acquired by the acquisition unit.

8. The image processing apparatus according to claim 1, wherein the determination unit is further configured to determine, if the ID of the frame acquired by the acquisition unit differs from the ID estimated by the estimation unit, that the frame rate of the video acquired by the acquisition unit has dropped.

9. The image processing apparatus according to claim 1, wherein the determination unit is further configured to determine a delay in the rendering processing regarding the frame acquired by the acquisition unit based on the ID of the frame acquired by the acquisition unit and the ID estimated by the estimation unit.

10. The image processing apparatus according to claim 1, further comprising a correction unit configured to perform, if the determination unit has determined that the frame rate of the video acquired by the acquisition unit has dropped, image correction on the frame acquired by the acquisition unit.

11. The image processing apparatus according to claim 10, wherein the correction unit is further configured to perform the image correction based on a delay in the rendering processing regarding the frame acquired by the acquisition unit.

12. The image processing apparatus according to claim 11, wherein the correction unit is further configured to perform the image correction based on a change in orientation of the display unit.

13. The image processing apparatus according to claim 11, wherein the image correction is shifting processing on an image or cutout processing from an image.

14. The image processing apparatus according to claim 1, wherein the image processing apparatus is a head mounted display.

15. The image processing apparatus according to claim 1, wherein the captured video is captured by an image capturing unit included in the image processing apparatus.

16. An image processing apparatus comprising:
an image capturing unit configured to capture a video including a plurality of frames;
an acquisition unit configured to acquire, frame by frame, a video obtained by performing rendering processing on each frame of the captured video;
a correction unit configured to perform image correction on a frame acquired by the acquisition unit; and
a display unit configured to display a video output from the correction unit,
wherein a period in which the display unit displays a video is divided into a plurality of subperiods,
a corresponding input period is prescribed to each of the plurality of subperiods,
the display unit is further configured to update the frame to be displayed at periodical update timings, and
the correction unit is further configured to determine whether or not the frame to be displayed in the display unit at a specific update timing has been acquired by the image capturing unit at the input period corresponding to the subperiod that includes the update timing, and perform image correction on a frame to be displayed in the display unit at the specific update timing in accordance with a result of the determination.

17. An image processing system comprising:
an image capturing unit configured to capture a video including a plurality of frames;
an assignment unit configured to assign an ID to each frame of the acquired video;
an image processing unit configured to output, frame by frame, a video to be displayed in a display unit by performing rendering processing on each frame of the video;
an estimation unit configured to estimate an ID of a frame to be output from the image processing unit; and
a determination unit configured to determine a drop in frame rate of the video output from the image processing unit, based on comparison between the ID of a frame output from the image processing unit and the ID estimated by the estimation unit.

18. The image processing system according to claim 17,
wherein the image processing system includes a head mounted display and an image processing apparatus,
the head mounted display includes:
the image capturing unit;
a first transmission unit configured to transmit the video captured by the image capturing unit to the image processing unit; and
the display unit, and
the image processing apparatus includes:
the image processing unit; and
a second transmission unit configured to transmit the video output from the image processing unit to the head mounted display.

19. An image processing method comprising:
acquiring, frame by frame, a video to be displayed in a display unit that is obtained by performing rendering processing on each frame of a captured video;
estimating an ID of a frame to be acquired; and
determining a drop in the frame rate of the acquired video, based on a comparison between an ID of an acquired frame and the estimated ID.

20. A non-transitory computer-readable medium storing a program which, when executed by a computer comprising a processor and a memory, causes the computer to perform a method comprising:
acquiring, frame by frame, a video to be displayed in a display unit that is obtained by performing rendering processing on each frame of a captured video;
estimating an ID of a frame to be acquired; and
determining a drop in the frame rate of the acquired video, based on a comparison between an ID of an acquired frame and the estimated ID.
